(19) United States
(12) Patent Application Publication
(10) Pub. No.: US 2007/0207920 A1
(43) Pub. Date: Sep. 6, 2007

(54) Production Method for Noble-Metal-Cluster-Supporting Catalyst

(75) Inventors: Hirohito Hirata, Shizuoka (JP); Shinichi Matsumoto, Aichi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, AICHI (JP)

(21) Appl. No.: 11/659,722

(22) PCT Filed: Aug. 11, 2005
(86) PCT No.: PCT/JP05/15037

§ 371 Date: Feb. 8, 2007

(30) Foreign Application Priority Data
Mar. 2, 2006 (JP) 2004-242592

(51) Int. Cl. B01J 23/00; B01J 23/44; B01J 23/42

(52) U.S. Cl. 502/325; 502/339

(57) ABSTRACT

The present invention provides a method for more easily producing a controlled-cluster-size noble-metal catalyst. This method comprises depositing a polynuclear complex comprising a plurality of organic polydentate ligands and a plurality of noble metal atoms on an oxide support, and then removing the organic polydentate ligands.

### TECHNICAL FIELD

The present invention relates to a production method for a catalyst. More specifically, the present invention relates to a production method for a catalyst having supported thereon a controlled-cluster-size noble metal.

### BACKGROUND ART

The exhaust gas discharged from an internal combustion engine such as an automobile engine contains carbon monoxide (CO), hydrocarbon (HC), nitrogen oxide (NOₓ) and the like, and these harmful substances are generally purified by an exhaust gas purifying catalyst obtained by loading a catalyst component mainly comprising a noble metal such as platinum (Pt), rhodium (Rh), palladium (Pd) and iridium (Ir) on an oxide support such as alumina.

A noble metal, as a catalyst component, is generally loaded on an oxide support by using a solution of a noble metal compound modified with a nitric acid group or an amine group, impregnating an oxide support with this solution to disperse the noble metal compound on the surface of the oxide support, and then firing it to remove the nitric acid group or the like. As for the oxide support, a material having a large specific area, such as γ-alumina, is generally used so that a large contact area with the catalyst component can be given to an exhaust gas.

Such a catalyst for the purification of an exhaust gas is required to be enhanced in the exhaust gas purifying performance and, as one approach thereto, the noble metal can be controlled to have an optimal cluster size.

More specifically, regarding certain noble metals, it is known that chemical properties such as catalytic activity or physical properties such as magnetism vary depending on the size of cluster (aggregate of atoms). In order to utilize the specific nature of this cluster, it is necessary to simply synthesize a large amount of clusters controlled in size. For producing clusters controlled in the size, a technique of evaporating a metal target in a vacuum to produce clusters of various sizes, and separating the clusters by use of the principle of a mass spectrum is employed at present, but the clusters cannot be prepared in large amounts. Furthermore, when a technique using a complex, which is utilized as a preparation method for catalysts, is employed, clusters can be simply prepared in a large amount but, as the number of noble metal atoms contained in the complex is only one, the supported noble metal is in a monoatomic dispersion state and a cluster having an arbitrary number of constituent atoms cannot be provided.

It has been heretofore been very difficult to load a noble metal, in only a desired cluster size, on an oxide support. The present applicant has previously proposed a method of introducing a noble metal into pores of a hollow carbon material such as carbon nanotube and carbon nanohorn, fixing the carbon material having introduced thereinto the noble metal to an oxide support, and firing it, thereby burning and removing the carbon material and at the same time, loading the noble metal in a cluster size on the oxide support (see, Japanese Unexamined Patent Publication (Kokai) No. 2003-181288).

According to this method, the noble metal is present in pores of the carbon material until the carbon material is burned and removed and under the conditions of burning and removing the carbon material, the noble metal is swiftly loaded on an oxide support, so that the noble metal in the pores of the carbon material can be loaded substantially in a given cluster size on the oxide support. However, carbon nanotubes or carbon nanohorns, as the carbon material, are not always easily available. An object of the present invention is to provide a method for more easily producing a noble metal catalyst with a controlled cluster size.

### DISCLOSURE OF THE INVENTION

In order to attain this object, the present invention provides a method for producing a noble metal cluster-supported catalyst, comprising depositing a polynuclear complex comprising a plurality of organic polydentate ligands and a plurality of noble metal atoms on an oxide support, and then removing the organic polydentate ligands.

Furthermore, in order to attain the object, the present invention provides a method for producing a noble metal cluster-supported catalyst, comprising reacting an OH group on the surface of an oxide support with an organic polydentate ligand to bond the organic polydentate ligand to the oxide support, reacting the organic polydentate ligand with a noble metal atom and another polydentate ligand to form a polynuclear complex which is bonded to the oxide support and comprises a plurality of organic polydentate ligands and a plurality of noble metal atoms, and then removing the organic polydentate ligands.

According to the method of the present invention, the noble metal atom and the organic polydentate ligand to be coordinated are selected so as to control the structure of the polynuclear complex formed and, therefore, the number of noble metal atoms constituting the cluster supported on the oxide support can be easily controlled. Furthermore, the polydentate ligand is previously bonded to the oxide support and a polynuclear complex is formed starting from the polydentate ligand, so that the position on which the polynuclear complex is supported can be arbitrarily controlled and a cluster can be loaded at an arbitrary position.

### BRIEF DESCRIPTION OF THE DRAWINGS

FIG. 1 is a view showing the process of the method of the present invention.

FIG. 2 is a view showing the process in another embodiment of the method of the present invention.

### BEST MODE FOR CARRYING OUT THE INVENTION

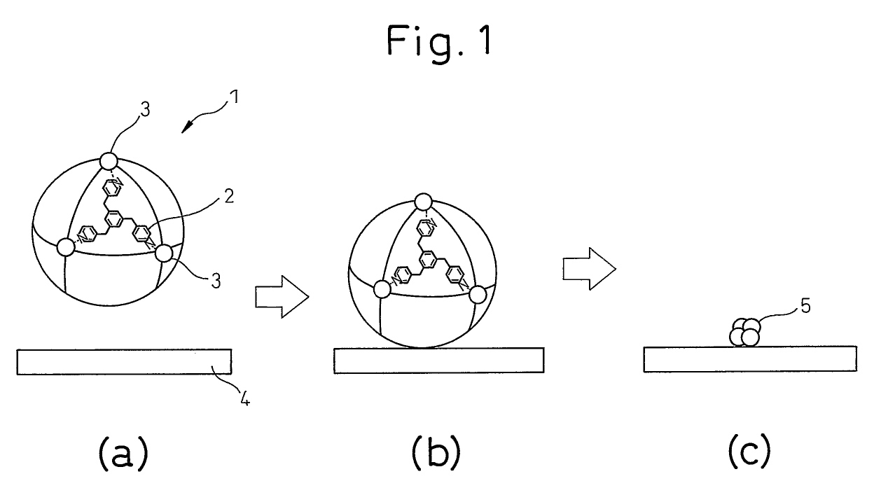

FIG. 1 shows the process of the present invention. In the method of the present invention, a polynuclear complex 1 comprising a plurality of organic polydentate ligands 2 and a plurality of noble metal atoms 3 is first prepared. This polynuclear complex 1 has a closed capsule-like structure and is prepared by reacting organic polydentate ligands 2 with noble metal atoms 3 according to the general production method for complexes.

As for the organic polydentate ligand 2, for example, the organic compounds shown below can be used.

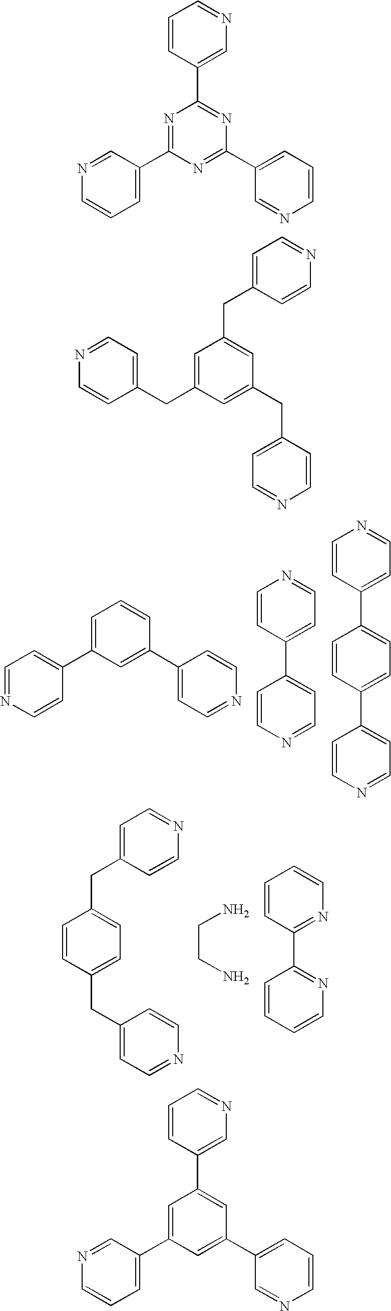

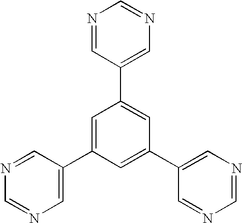

As for the noble metal atom 3, at least one member selected from platinum, rhodium, palladium, gold and iridium can be used.

Specifically, when the compound shown blow: 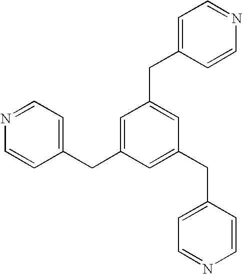
is used as the organic polydentate ligand 2, a capsule-like molecule having an M₆L₈ composition, shown below: 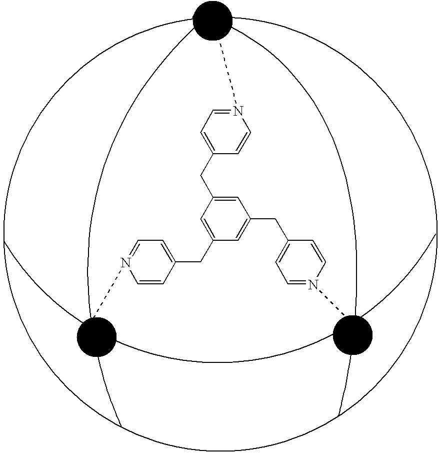
is obtained as the polynuclear complex 1.

Also, when a compound shown below: 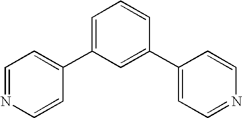
is used as the organic polydentate ligand 2, a capsule-like molecule having an M₁₂L₂₄ composition, shown below: 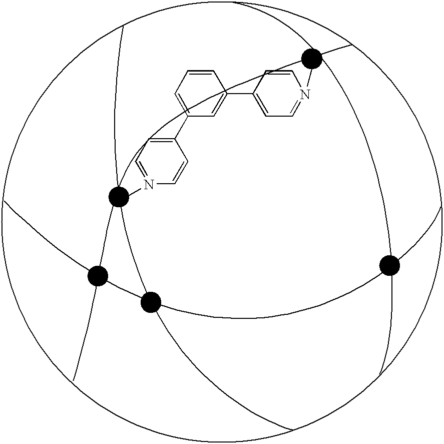
is obtained.

Then, as shown in FIG. 1(a), an oxide support 4 is dipped in a solution containing the polynuclear complex 1. Subsequently, as shown in FIG. 1(b), the solvent is removed by drying, whereby the polynuclear complex 1 is deposited on the oxide support 4. As for the oxide support 4, those comprising an oxide generally used as a support for catalysts, such as alumna, silica, zirconia and ceria, and those comprising a composite oxide such as silica-alumina, zirconia-ceria, alumina-ceria-zirconia, ceria-zirconia-yttria, and zirconia-calcia, are suitable.

Thereafter, as shown in FIG. 1(c), the polynuclear complex 1 deposited on the oxide support 4 is heated or irradiated with ultraviolet ray, microwave, ozone or the like and, as a result, the organic polydentate ligand 2 constituting the polynuclear complex 1 is decomposed or burned and thereby removed and a cluster 5 of noble metals 2 is supported on the surface of the oxide support 4. For example, when the polynuclear complex is heated under the conditions of 400 to 800° C.×1 to 5 hours in an air atmosphere, the organic polydentate ligand 2 is burned and removed and, at the same time, the noble metals 3 coordinated to the organic polydentate ligand 2 aggregate and thereby can be supported on the oxide support 4 in a cluster size corresponding to the coordination number of the organic polydentate ligand 2.

In the method described above, a previously prepared polynuclear complex is deposited on an oxide support but, in this case, the position on the oxide support, at which the polynuclear complex is deposited, cannot be arbitrarily controlled. Therefore, in the second invention, one of the polydentate ligands constituting the polynuclear complex is previously bonded to an arbitrary position on the oxide support and a polynuclear complex is formed starting from this polynuclear ligand, whereby a polynuclear complex can be bonded to an arbitrary position of the oxide support.

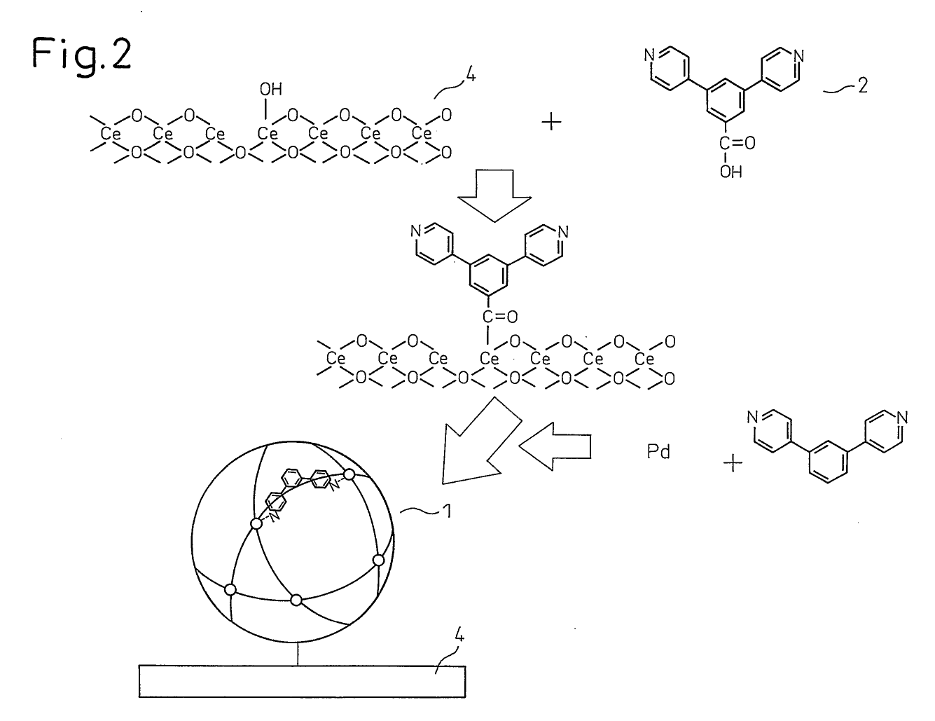

Specifically, as shown in FIG. 2, an OH group is provided at an arbitrary position on an oxide support 4 (in FIG. 2, ceria), and this OH group is reacted with an organic polydentate ligand 2 (FIG. 2(a)) to bond the organic polydentate ligand 2 to an arbitrary position of the oxide support 4 (FIG. 2(b)). This organic polydentate ligand 2 is reacted with a noble metal atom and another organic polydentate ligand to form a capsule-like polynuclear complex 1 at that position (FIG. 2(c)). Thereafter, the organic polydentate ligand is removed in the same manner as above, whereby a cluster 5 of noble metals 2 can be supported at an arbitrary position.

As for the polydentate ligand to be first bonded to the oxide support, a compound in which an OH group or COOH group coming to react with the OH group on the oxide support is imparted to the above-described organic polydentate ligand, for example, a compound shown below: 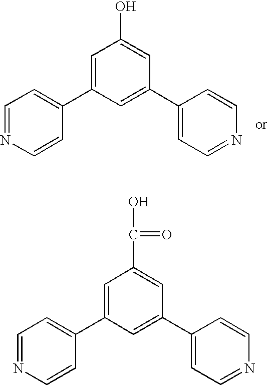
may be used.

1. A method for producing a noble metal cluster-supporting catalyst, comprising depositing a polynuclear complex comprising a plurality of organic polydentate ligands and a plurality of noble metal atoms on an oxide support, and then removing the organic polydentate ligands, wherein the organic polydentate ligand is any one organic compound shown below:

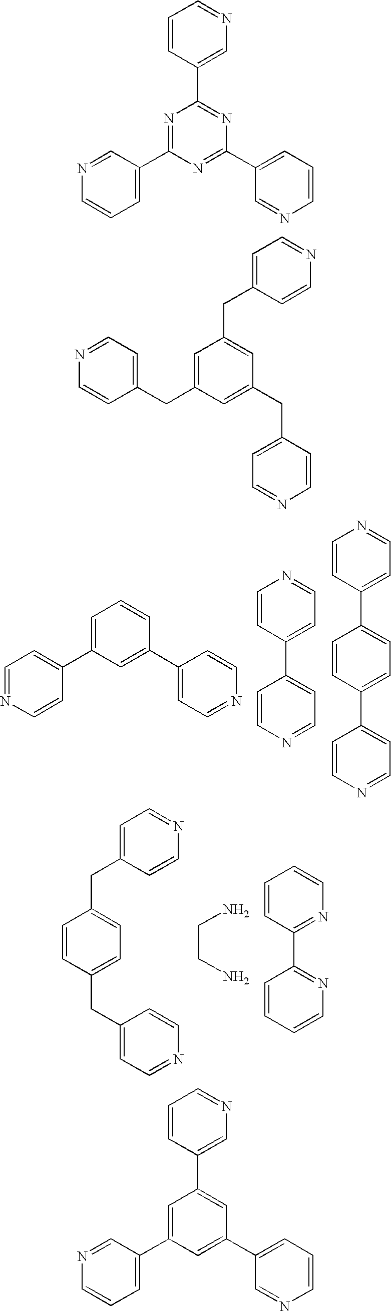

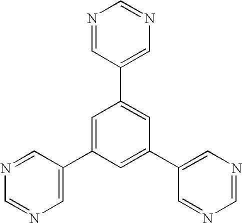

2. A method for producing a noble metal cluster-supported catalyst, comprising reacting an OH group on the surface of an oxide support with an organic polydentate ligand to bond the organic polydentate ligand to the oxide support, reacting the organic polydentate ligand with a noble metal atom and another organic polydentate ligand to form a polynuclear complex which is bonded to the oxide support and comprises a plurality of organic polydentate ligands and a plurality of noble metal atoms, and then removing the organic polydentate ligands.

3. The method as claimed in claim 2, wherein the organic polydentate ligand is any one organic compound shown below:

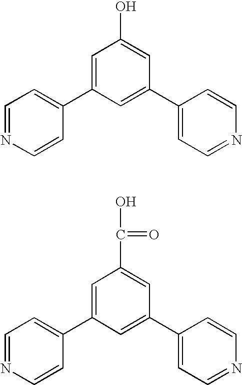

4. The method as claimed in claim 1, wherein the noble metal atom is at least one member selected from platinum, rhodium, palladium, and iridium.

5. The method as claimed in claim 1, wherein the polynuclear complex is heated or irradiated with ultraviolet ray, microwave or ozone to bum or decompose the organic polydentate ligands and thereby remove the organic polydentate ligands.

6. The method as claimed in claim 2, wherein the noble metal atom is at least one member selected from platinum, rhodium, palladium, and iridium.

7. The method as claimed in claim 2, wherein the polynuclear complex is heated or irradiated with ultraviolet ray, microwave or ozone to bum or decompose the organic polydentate ligands and thereby remove the organic polydentate ligands.
